(19) United States
(12) Patent Application Publication
(10) Pub. No.: US 2018/0177159 A1
(43) Pub. Date: Jun. 28, 2018

(54) BEE-KEEPING EQUIPMENT AND TEMPERATURE ADJUSTING DEVICE THEREOF

(71) Applicant: NATIONAL TAIWAN UNIVERSITY, Taipei City (TW)

(72) Inventors: Joe-Air Jiang, Taipei City (TW); En-Cheng Yang, Taipei City (TW); Hung-Jen Lin, Taipei City (TW); Chien-Hao Wang, Taipei City (TW); Chien-Peng Huang, Taipei City (TW)

(21) Appl. No.: 15/583,925

(22) Filed: May 1, 2017

(30) Foreign Application Priority Data
Dec. 28, 2016 (TW) 105143636

(51) Int. Cl. A01K 51/00; A01K 49/00; H05B 1/02; H05B 3/34

(52) U.S. Cl. CPC A01K 51/00; A01K 49/00; H05B 2203/013; H05B 3/34; H05B 1/0288

(57) ABSTRACT

A bee-keeping equipment includes a container, and a temperature adjusting device including conductive elements, a hive frame, a temperature adjusting circuit and two conductive films. Each conductive element is configured at an upper edge of each sidewall of the container. Metal through holes are arranged at the inner side of the hive frame. The temperature adjusting circuit includes heating elements. One end of each heating element is inserted into one metal through hole, and the other end of each heating element is inserted into another metal through hole to form a net-structure for supporting a hive. The conductive films are electrically connected to the metal through holes. The hive frame has two extending portions. The conductive films are respectively configured under the extending portions.

### CROSS-REFERENCE TO RELATED APPLICATION

This application claims benefit of Taiwan, R.O.C. patent application no. 105143636 filed Dec. 28, 2016, the disclosure of which is hereby incorporated by reference in its entirety for all purposes.

### BACKGROUND OF THE INVENTION

### 1. Field of the Invention

The present disclosure relates to a bee-keeping equipment that can accommodate beehive; in particular, to a bee-keeping equipment having a temperature adjusting function and a temperature adjusting device thereof.

### 2. Description of Related Art

For the bee-keeping industry, the temperature adjustment of a bee-keeping equipment is important for hatching bee eggs and for keeping the larvae alive. In order to adjust the temperature of the bee-keeping equipment, many bee keepers choose to have an external heating plate configured in the bee-keeping equipment for increasing the temperature of the bee-keeping equipment to a temperature that is more suitable for hatching bee eggs and keeping the larvae alive.

However, the hive cannot be evenly heated by using the external heating plate. Consequently, not all bee eggs can be hatched, and thus the productivity of the bees decreases. Additionally, the external heating plate needs to be electrically connected to the bee-keeping equipment through additional wirings that are exposed outside the bee-keeping equipment. Thus, when a bee keeper or a researcher checks the hive, he needs to be constantly aware of the wirings, which cannot be displaced. Moreover, the external heating plate increases the temperature of the hive by heating the air in the bee-keeping equipment and not by directly heating the hive, which inevitably results in heat loss.

### SUMMARY OF THE INVENTION

The present disclosure provides a temperature adjusting device that is used in a bee-keeping equipment. The bee-keeping equipment has a container and a cover, and is used for accommodating a plurality of hives formed of bee wax. The temperature adjusting device includes a plurality of conductive elements, a hive frame, a temperature adjusting circuit and at least two conductive films. Each of the conductive elements is configured at an upper edge of each sidewall of the container. A plurality of metal through holes is arranged at the inner side of the hive frame. The temperature adjusting circuit includes a plurality of heating elements. One end of each heating element is inserted into one metal through hole, and the other end of each heating element is inserted into another metal through hole to form a net-structure for supporting a hive. The two conductive films are electrically connected to the metal through holes. The hive frame has two extending portions. The extending portions extend from two ends of one side frame of the hive frame respectively. The two conductive films are respectively configured under the two extending portions. When the hive frame is put into the bee-keeping equipment such that the extending portions of the hive frame are connected with the conductive elements of the container, a current provided by an external power supply flows to the heating elements through the metal through holes to generate heat for increasing the temperature of the hive.

In one embodiment of the temperature adjusting device provided by the present disclosure, the temperature adjusting circuit further includes a relay, and the relay is connected between the metal through holes and one of the conductive films. In this embodiment, the temperature adjusting device further includes a temperature detection circuit. This temperature detection circuit includes a temperature sensor and a microprocessor. The temperature sensor is configured at a surface of the hive for detecting the temperature at the surface of the hive. The microprocessor is connected to the relay and the temperature sensor. The temperature sensor continually detects and transmits the detected temperature at the surface of the hive to the microprocessor. When the microprocessor determines that the temperature at the surface of the hive is equal to or larger than a threshold temperature, the microprocessor turns off the relay such that there is no current flowing to the heating elements through the metal through holes and the hive is not heated. After the microprocessor turns off the relay, the temperature at the surface of the hive gradually and slowly decreases. When the microprocessor determines that a difference between the temperature at the surface of the hive and the threshold temperature is larger than a value, the microprocessor turns on the relay such that the current flows to the heating elements through the metal through holes to again heat the hive. In another embodiment of the temperature adjusting device provided by the present disclosure, when the microprocessor determines that the temperature at the surface of the hive is equal to the threshold temperature, the microprocessor alternately turns off and turns on the relay at a predetermined frequency to keep the temperature at the surface of the hive at the threshold temperature.

In one embodiment of the temperature adjusting device provided by the present disclosure, the heating elements are made of metals having a high conductivity, and the hive frame and the extending portions are made of an insulating material.

In one embodiment of the temperature adjusting device provided by the present disclosure, the conductive films are electrically connected to the metal through holes by conductive lines embedded in the hive frame.

In one embodiment of the temperature adjusting device provided by the present disclosure, when the hive frame is withdrawn from the bee-keeping equipment such that the extending portions of the hive frame are disconnected with the conductive elements on the container, there is no current flowing to the heating elements through the metal through holes and the hive is not heated.

The present disclosure further provides a bee-keeping equipment having a temperature adjusting function. This bee-keeping equipment includes a container and a cover to accommodate a plurality of hives made of bee wax. A temperature adjusting device is configured in this bee-keeping equipment to dynamically adjust the temperature at the surface of the hive. This temperature adjusting device includes a conductive element, a hive frame, a temperature adjusting circuit and at least two conductive films. The conductive element is configured at an upper edge of each sidewall of the container. The hive frame has a plurality of metal through holes arranged at the inner side of the hive frame. The temperature adjusting circuit includes a plurality of heating elements. One end of each heating element is inserted into one metal through hole, and the other end of each heating elements is inserted into another metal through hole, and thus a net-structure is formed to support a nest. The two conductive films are electrically connected to the metal through holes. The nest frame has two extending portions. The extending portions extend from two ends of one side frame of the nest frame respectively. The two conductive films are respectively configured under the two extending portions. When the nest frame is put into the bee-keeping equipment such that the extending portions of the nest frame is connected with the conductive elements of the container, a current provided by an external power supply flows to the heating elements through the metal through holes to generate heat for increasing the temperature of the nest.

To sum up, the bee-keeping equipment provided by the present disclosure and the temperature adjusting device thereof are easy to use. When a bee keeper puts a hive frame into the container of the equipment, the whole hive frame can be held by hanging two extending portions of the hive frame on the upper edges of two sidewalls of the container. In this manner, heat can be generated by heating elements to increase the temperature at the surface of the hive. On the other hand, when one of the hives needs not be heated, the bee keeper can simply withdraw said hive with its hive frame. In this manner, said hive is not heated because its hive frame is disconnected from the conductive elements, but the temperature at the surface of other hives in the bee-keeping equipment can still be dynamically adjusted.

For further understanding of the present disclosure, reference is made to the following detailed description illustrating the embodiments of the present disclosure. The description is only for illustrating the present disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic diagram of a temperature adjusting device of one embodiment of the present disclosure.

FIG. 2 shows a schematic diagram illustrating that the conductive films of the temperature adjusting device are connected with the conductive elements of the bee-keeping equipment.

FIG. 3 shows a block diagram of a temperature adjusting circuit and a temperature detection circuit of a temperature adjusting device of one embodiment of the present disclosure.

### DETAILED DESCRIPTION OF EXEMPLARY EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

### One Embodiment of the Temperature Adjusting Device

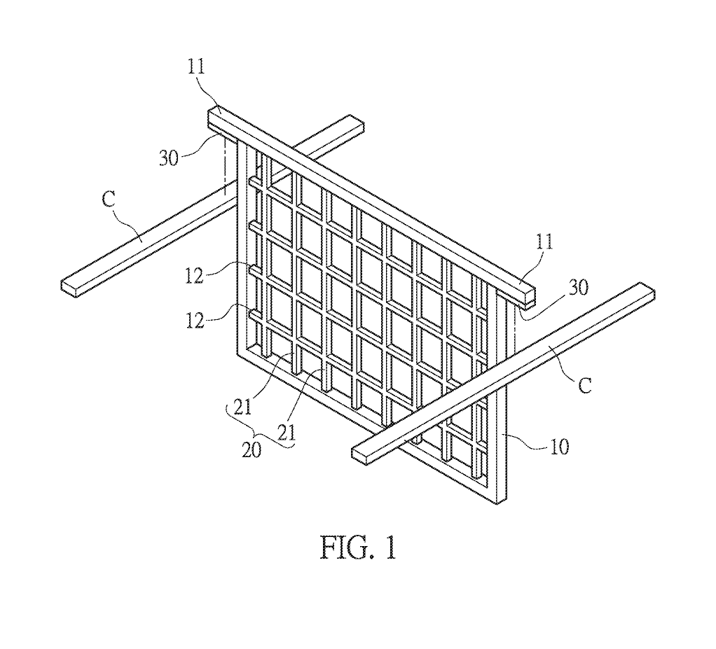

Referring to FIG. 1, a schematic diagram of a temperature adjusting device of one embodiment of the present disclosure is shown. The temperature adjusting device provided in this embodiment can be configured in a bee-keeping equipment. The temperature adjusting device is mainly used to control the temperature of the hives accommodated in the bee-keeping equipment, because the temperature of the nests in the bee-keeping equipment needs to be controlled at a proper temperature for hatching bee eggs.

Generally, a bee-keeping equipment has a container and a cover. The container of the bee-keeping equipment can contain a plurality of hives made of bee wax. As shown in FIG. 1, the temperature adjusting device in this embodiment includes conductive elements C, a hive frame 10, a temperature adjusting circuit 20 and at least two conductive films 30.

Each conductive element C is configured at an upper edge of each sidewall of the container. A plurality of metal through holes 12 are arranged at the inner side of the hive frame 10. The temperature adjusting circuit 20 includes a plurality of heating elements 21. One end of each heating element 21 is inserted into one metal through hole 12, and the other end of each heating element 21 is inserted into another metal through hole 12, and thus a net-structure is formed for supporting a hive that is made of bee wax. In addition, the hive frame 10 has at least two extending portions 11. As shown in FIG. 1, the extending portions 11 extend from two ends of one side frame of the hive frame 10 respectively, and the hive attached to the above described net-structure is held by hanging the two extending portions 11 of the hive frame 10 on the upper edges of two sidewalls of the container.

It should be noted that, the heating elements 21 are made of metals having a high conductivity. This kind of metal can sustain high power energy and has great flexibility. When assembling the temperature adjusting device provided by this embodiment, a bee keeper can easily bend the net-structure formed by the heating element 21 to engage the net-structure into the metal through holes 12 arranged at the inner side of the hive frame 10. In addition, the two conductive films 30 are respectively configured under the two extending portions 11 of the hive frame 10 (as shown by FIG. 1). In this manner, when the hive frame 10 is put into the bee-keeping equipment, the hive frame 10 can be held by hanging the two extending portions 11 of the hive frame 10 on the upper edges of two sidewalls of the bee-keeping equipment.

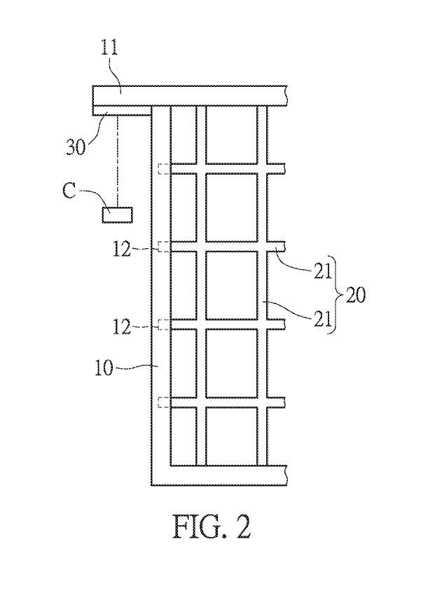

FIG. 2 illustrates how the temperature adjusting device provided by this embodiment can generate heat to increase the temperature of the hive attached to the heating element 21. Referring to FIG. 2, a schematic diagram illustrating that the conductive films of the temperature adjusting device are connected with the conductive elements of the bee-keeping equipment is shown. When the two extending portions 11 of the hive frame 10 are hung on the upper edges of two sidewalls of the container of the bee-keeping equipment, the two conductive films 30 under the two extending portions 11 can be connected to the conductive elements C configured at upper edges of sidewalls of the container of the bee-keeping equipment. When an external power supply is provided to the conductive elements C, a current is generated and flows to the two conductive films 30 through the conductive elements C. As shown in FIG. 2, the conductive films 30 are electrically connected to the metal through holes 12 through the conductive lines embedded in the hive frame 10. In this manner, the current flowing to the two conductive films 30 can further flow to the metal through holes 12 arranged at the inner side of the hive frame 10 through the conductive lines. Finally, the current flows to the heating elements 21 through the metal through holes 12. As described, the heating elements 21 are made by a metal that can sustain high power energy, so when the current flows through the heating elements 21 an electric energy is converted to heat that can increase the temperature of the hive.

It is worth mentioning that, in this embodiment, the hive frame 10 and the extending portions 11 of the hive frame 10 are made of an insulating material. As described, the metal through holes 12 are arranged at the inner side of the hive frame 10, and the conductive lines are embedded in the hive frame 10. Thus, when a bee keeper needs to put the hive frame 10 into the container of the bee-keeping equipment, it would be safe for him to grab two sides of the extending portions 11 (the two sides which are parallel with the hive), or to grab one side frame of the hive frame 10 (the extending portions 11 extend from two ends of this side frame respectively), for putting the hive frame 10 into the container of the bee-keeping equipment or for withdrawing the hive frame 10 from the container of the bee-keeping equipment, without the risk of being hurt by an electric shock.

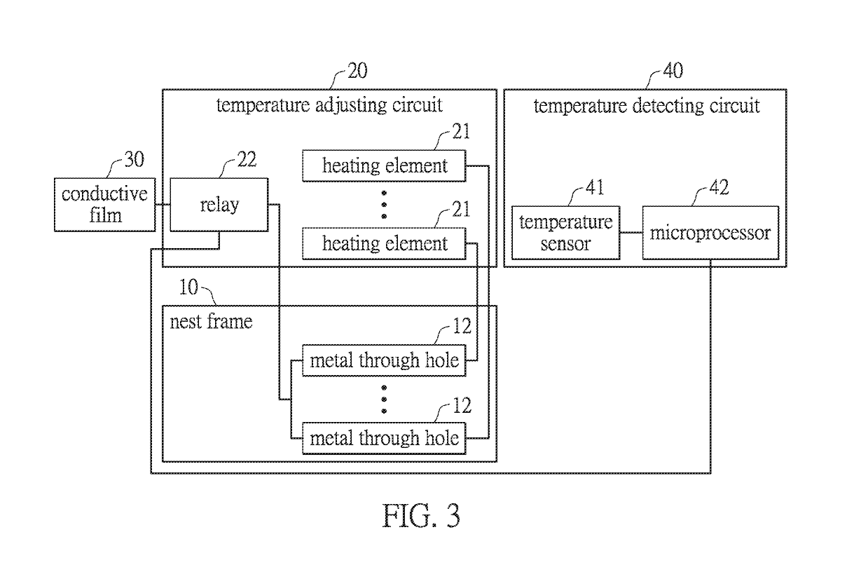

FIG. 3 illustrates how the temperature adjusting device provided by this embodiment can adjust the temperature of the hive attached to the heating elements 21. Referring to FIG. 3, a block diagram of a temperature adjusting circuit and a temperature detection circuit of a temperature adjusting device of one embodiment of the present disclosure is shown.

In order to adjust the temperature of the hive attached to the heating elements 21, the temperature adjusting device provided by this embodiment further includes a temperature detecting circuit 40. The temperature detecting circuit 40 includes a temperature sensor 41 and a microprocessor 42. The temperature sensor 41 is connected to the microprocessor 42, and the temperature sensor 41 is configured at the surface of the hive to detect the temperature at the surface of the hive. The temperature sensor 41 continually detects and transmits the temperature at the surface of the hive to the microprocessor 42. In this embodiment, the temperature adjusting circuit 20 further includes a relay 22. The relay 22 is electrically connected between the metal through holes 12 and one of the conductive films 30 through the conductive lines. Additionally, the relay 22 is connected to the microprocessor 42 of the temperature detecting circuit 40.

As shown in FIG. 3, during the process in which the temperature sensor 41 continually detects and transmits the temperature at the surface of the hive to the microprocessor 42, the microprocessor 42 determines whether the temperature at the surface of the hive is larger than or equal to a threshold temperature. When the microprocessor 42 determines that the temperature at the surface of the hive is larger than or equal to a threshold temperature, the microprocessor 42 turns off the relay 22 in the temperature adjusting circuit 20. As a result, no current flows to the heating elements 21 through the metal through holes 12, and the hive is not heated.

After the microprocessor 42 turns off the relay 22 in the temperature adjusting circuit 20, the temperature at the surface of the hive gradually and slowly decreases because the hive is not heated. At this time, the temperature sensor 41 continually detects and transmits the temperature at the surface of the hive to the microprocessor 42. When the microprocessor 42 determines that a difference between the temperature at the surface of the hive and the threshold temperature is larger than a value (such as 0.5° C.), the microprocessor 42 turns on the relay 22. As a result, a current is generated and flows to the heating elements 21 through the metal through holes 12, and the hive is heated again. In this manner, the temperature adjusting device provided by this embodiment can dynamically adjust the temperature at the surface of the hive attached to the heating elements 21 to prevent bee eggs from being damaged due to an over-elevated temperature. However, when the microprocessor 42 determines that a difference between the temperature at the surface of the hive and the threshold temperature is much larger than the value (such as 0.5° C.), the microprocessor 42 does not turn on the relay 22, because this large temperature difference may be caused by, for example, a fire hazard that happened nearby.

The temperature adjusting device provided by other embodiments of the present disclosure may dynamically adjust the temperature at the surface of the hive attached to the heating elements 21 in other ways. In another embodiment, during the process in which the temperature sensor 41 continually detects and transmits the temperature at the surface of the hive to the microprocessor 42, the microprocessor 42 determines whether the temperature at the surface of the hive is equal to a threshold temperature. When the microprocessor 42 determines that the temperature at the surface of the hive is equal to a threshold temperature, the microprocessor 42 alternately turns off and turns on the relay 22 at a predetermined frequency to keep the temperature at the surface of the hive at the threshold temperature. In this manner, the temperature at the surface of the hive can be maintained at the threshold temperature that is more suitable for hatching the bee eggs.

It is worth mentioning that, when the hive frame 10 is withdrawn from the container of the bee-keeping equipment, the extending portions 11 of the hive frame 10 are disconnected from the conductive elements 30 on the container. Thus, no current flows to the heating elements 21 through the metal through holes 12, and the hive is not heated.

### One Embodiment of the Bee-keeping Equipment

A bee-keeping equipment having a temperature adjusting function is provided by this embodiment. This bee-keeping equipment includes a container and a cover, and the container of the bee-keeping equipment can accommodate a plurality of hives made of bee wax. In addition, one of the temperature adjusting devices provided by the above embodiments is configured in this bee-keeping equipment to dynamically adjust the temperature at the surface of the hive.

To sum up, the bee-keeping equipment provided by the present disclosure and the temperature adjusting device thereof are easy to use for a bee keeper. When the bee keeper puts a hive frame into the container of the equipment, the whole hive frame can be held by hanging two extending portions of the hive frame on the upper edges of two sidewalls of the container. In this manner, heat can be generated by heating elements to dynamically adjust the temperature at the surface of the hive. On the other hand, when one of the hives needs not be heated, the bee keeper can simply withdraw the hive with its hive frame from the bee-keeping equipment. In this manner, the withdrawn hive is not heated because its hive frame is disconnected with the conductive elements, but the temperature at the surface of other hives in the bee-keeping equipment can still be dynamically adjusted.

In addition, a bee keeper can conveniently assemble the temperature adjusting device provided by this embodiment. When assembling the temperature adjusting device, the bee keeper can easily bend the net-structure formed by the heating elements to engage the net-structure into the metal through holes arranged at the inner side of the hive frame. After that, the bee keeper needs only to put the hive frame into the container of the bee-keeping equipment, such that the hive frame is held by hanging the two extending portions of the hive frame on the upper edges of two sidewalls of the bee-keeping equipment. In this manner, a current is generated and flows to the heating elements to generate heat for increasing the temperature at the surface of the hive.

Moreover, by using the bee-keeping equipment provided by the present disclosure and the temperature adjusting device thereof, the temperature at the surface of the hive can be dynamically adjusted and kept at a threshold temperature that is more suitable for hatching bee eggs or for the larvae to stay alive. Therefore, the bee-keeping equipment provided by the present disclosure and the temperature adjusting device thereof helps to increase the productivity of the bee-keeping industry.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A temperature adjusting device, used in a bee-keeping equipment, wherein the bee-keeping equipment has a container and a cover and is used for accommodating at least one hive formed of bee wax, comprising:
a plurality of conductive elements, wherein each conductive element is configured at an upper edge of each sidewall of the container;
a hive frame, having a plurality of metal through holes arranged at an inner side of the hive frame;
a temperature adjusting circuit, including:
a plurality of heating elements, wherein one end of each heating element is inserted into one metal through hole and the other end of each heating element is inserted into another metal through hole to form a net-structure for supporting a hive; and
at least two conductive films, electrically connected to the metal through holes;
wherein the hive frame has two extending portions, the extending portions extend from two ends of one side frame of the hive frame respectively, the two conductive films are respectively configured under the two extending portions, and when the hive frame is put into the bee-keeping equipment such that the extending portions of the hive frame are connected with the conductive elements of the container, a current provided by an external power supply flows to the heating elements through the metal through holes to generate heat for increasing the temperature of the hive.

2. The temperature adjusting device according to claim 1, wherein the temperature adjusting circuit further includes a relay, and the relay is connected between the metal through holes and one of the conductive films.

3. The temperature adjusting device according to claim 2, further comprising:
a temperature detection circuit, including:
a temperature sensor, configured at a surface of the hive for detecting the temperature at the surface of the hive; and
a microprocessor, connected to the relay and the temperature sensor, wherein the temperature sensor continually detects and transmits the detected temperature at the surface of the hive to the microprocessor;
wherein when the microprocessor determines that the temperature at the surface of the hive is equal to or larger than a threshold temperature, the microprocessor turns off the relay such that there is no current flowing to the heating elements through the metal through holes and the hive is not heated.

4. The temperature adjusting device according to claim 3, wherein after the microprocessor turns off the relay, when the microprocessor determines that a difference between the temperature at the surface of the hive and the threshold temperature is larger than a value, the microprocessor turns on the relay such that the current flows to the heating elements through the metal through holes to again heat the hive.

5. The temperature adjusting device according to claim 3, wherein when the microprocessor determines that the temperature at the surface of the hive is equal to the threshold temperature, the microprocessor alternately turns off and turns on the relay at a predetermined frequency to keep the temperature at the surface of the hive at the threshold temperature.

6. The temperature adjusting device according to claim 1, wherein the heating elements are made of metals having a high conductivity.

7. The temperature adjusting device according to claim 1, wherein the hive frame and the extending portions are made of an insulating material.

8. The temperature adjusting device according to claim 1, wherein the conductive films are electrically connected to the metal through holes by conductive lines embedded in the hive frame.

9. The temperature adjusting device according to claim 1, wherein when the hive frame is withdrawn from the bee-keeping equipment such that the extending portions of the hive frame are disconnected with the conductive elements on the container, no current flows to the heating elements through the metal through holes and the hive is not heated.

10. A bee-keeping equipment having a temperature adjusting function, comprising a container and a cover to accommodate a plurality of hives made of bee wax, and comprising a temperature adjusting device according to claim 1 to dynamically adjust the temperature at the surface of the hive.
